(19) United States
(12) Patent Application Publication
(10) Pub. No.: US 2013/0257878 A1
(43) Pub. Date: Oct. 3, 2013

(54) METHOD AND APPARATUS FOR ANIMATING STATUS CHANGE OF OBJECT

(71) Applicant: SAMSUNG ELECTRONICS CO., LTD., Gyeonggi-do (KR)

(72) Inventor: Fredrick Jin, Gyeonggi-do (KR)

(73) Assignee: Samsung Electronics Co., Ltd., Gyeonggi-do (KR)

(21) Appl. No.: 13/852,952

(22) Filed: Mar. 28, 2013

(30) Foreign Application Priority Data
Apr. 3, 2012 (KR) 10-2012-0034404

(51) Int. Cl. G06T 13/00

(52) U.S. Cl. CPC G06T 13/00
USPC 345/473; 345/173

(57) ABSTRACT

An apparatus and a method for animating a status change of an object on a display. The apparatus for animating a status change of an object includes a display unit, an input unit, one or more processors, a memory, and one or more modules. The display unit displays a status change process of a first object. The input unit receives a status change instruction for the first object. One or more modules are stored in the memory and executed by the one or more processors. The module displays a second object in response to the status change instruction to animate a status change of the first object.

### CROSS-REFERENCE TO RELATED APPLICATION(S) AND CLAIM OF PRIORITY

The present application is related to and claims the benefit under 35 U.S.C. § 119(a) of a Korean patent application No. 10-2012-0034404 filed on Apr. 3, 2012 in the Korean Intellectual Property Office, the entire disclosure of which is hereby incorporated by reference.

### TECHNICAL FIELD OF THE INVENTION

The present disclosure relates to a method and an apparatus for changing a status of an object in an electronic device. More particularly, the present disclosure relates to a method and an apparatus for applying an effect of the status change of the object in an electronic device.

### BACKGROUND OF THE INVENTION

Recently, as a portable terminal develops rapidly, the portable terminal enabling wireless voice communication and information exchange has become a daily necessity. In an early stage of distribution of the portable terminal, the portable terminal has been simply recognized as a terminal that can be carried with and enables wireless communication, but as technology of the portable terminal has been developed and wireless Internet has been introduced, the portable terminal is not only used for the purpose of simple telephone communication and schedule management, but also expands its utilization range to such as games, a remote controller using short distance communication, and capturing an image using a built-in camera, meeting a user's need.

In addition, recently, a smart phone that has combined an advantage of a mobile communication terminal with one of a Personal Digital Assistant (PDA) has been brought to the market. The smart phone denotes a terminal reinforcing a data communication function such as schedule management, fax transmission/reception, an Internet access, etc. The smart phone may additionally download and install applications selected by a user and execute them.

Accordingly, the portable terminal may store large data, which may be added or deleted by a user.

Generally, the portable terminal processes data using a Graphic User Interface (GUI) and provides a convenience to a user by allowing the user to delete or install data using the GUI.

However, the portable terminal provides only basic information regarding a data processing process to the user and so it does not provide an interest to the user while processing data. That is, the portable terminal represents a data processing process or processing status using an icon representing deletion of data and installation of data and so it does not provide satisfaction regarding the data processing process to the user.

Therefore, to resolve the above problem, an apparatus and a method for providing user's satisfaction regarding a data processing process in a portable terminal are required.

### SUMMARY OF THE INVENTION

To address the above-discussed deficiencies of the prior art, it is a primary object to provide an apparatus and a method for animating a status change of an object in an electronic device.

Another aspect of the present disclosure is to provide an apparatus and a method for animating a status change of a first object using a second object in an electronic device.

Still another aspect of the present disclosure is to provide an apparatus and a method for displaying a second object according to the type of a status change of a first object in an electronic device.

Yet another aspect of the present disclosure is to provide an apparatus and a method for operating a second object according to the type of a status change of a first object in an electronic device.

In accordance with an aspect of the present disclosure, an apparatus for animating a status change of an object in an electronic device is provided. The apparatus includes a display unit for displaying a status change process of a first object, an input unit configured to receive a status change instruction of the first object, one or more processors, a memory, and one or more modules stored in the memory and configured for execution by the one or more processors, wherein the module displays a second object in response to the status change instruction to animate a status change of the first object.

In accordance with another aspect of the present disclosure, a method for animating a status change of an object in an electronic device is provided. The method includes displaying a first object, receiving a status change instruction of the first object, and animating a status change of the first object using a second object in response to the status change instruction.

In accordance with still another aspect of the present disclosure, an electronic device for animating a status change of an object is provided. The device includes a display means configured to display a first object, an input means configured to receive a status change instruction of the first object, and a processing means configured to perform a status change process of the first object using a second object in response to the status change instruction.

In accordance with further another aspect of the present disclosure, an apparatus for performing a status change of an object in an electronic device is provided. The apparatus includes a wireless communication unit, a touchscreen display configured to receive instruction and display a status change process of a first object, one or more processors operating by being connected with the touchscreen and the wireless communication unit, a memory, and one or more modules stored in the memory and configured for execution by the one or more processors, wherein the module controls to display a second object in response to a status change instruction of the first object received via the wireless communication unit to display the second object, thereby performing a status change of the first object.

Other aspects, advantages and salient features of the disclosure will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device that applies an effect on an object whose status changes according to an exemplary embodiment of the present disclosure;

FIG. 2 is a flowchart illustrating a process for animating a status change of an object in an electronic device according to an exemplary embodiment of the present disclosure;

FIG. 3 is a flowchart illustrating a process for animating a status change of an object in an electronic device according to an exemplary embodiment of the present disclosure;

FIG. 4 is a flowchart illustrating a process for animating a status change of an object in an electronic device according to an exemplary embodiment of the present disclosure;

FIGS. 5A-5B illustrate the exemplary screens showing a status change of object in an electronic device according to an exemplary embodiment of the present disclosure;

FIGS. 6A-6D illustrate exemplary icons in the configuration for status change of objects used by an electronic device according to an exemplary embodiment of the present disclosure;

FIGS. 7A-7F illustrate exemplary icons for animating a status change of objects used by an electronic device according to an exemplary embodiment of the present disclosure;

FIGS. 8A-8C illustrate a process for animating a status change of an object in an electronic device according to an exemplary embodiment of the present disclosure;

FIGS. 9A-9D illustrate a process for animating a status change of an object in an electronic device according to an exemplary embodiment of the present disclosure; and

FIGS. 10A-10F illustrate a process for animating a change in a status of an object in an electronic device according to an exemplary embodiment of the present disclosure.

Throughout the drawings, like reference numerals will be understood to refer to like parts, components and structures.

### DETAILED DESCRIPTION OF EXEMPLARY EMBODIMENTS

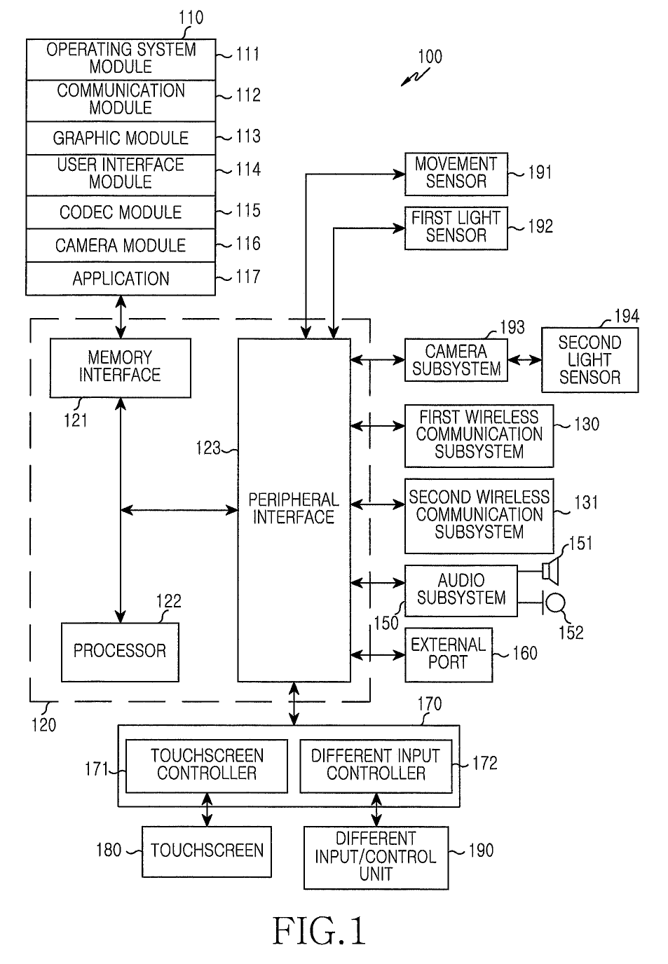

FIGS. 1 through 10F, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

Exemplary embodiments of the present disclosure provide an apparatus and a method for applying an effect on an object whose status changes in an electronic device. Here, applying an effect to an object denotes changing a status of a first object using a second object. In addition, in the following description, the first object denotes all objects whose status may be changed (for example, deleted, transmitted, shared, etc.) by a user of an electronic device, and the second object denotes another object that changes a status of the first object while transforming the shape of the first object.

FIG. 1 is a block diagram illustrating an electronic device that applies an effect on an object whose status changes according to an exemplary embodiment of the present disclosure.

Referring to FIG. 1, the electronic device 100 can be a portable electronic device. The electronic device can be a device such as a portable terminal, a mobile phone, a mobile pad, a media player, a tablet computer, a handheld computer, and a Personal Digital Assistant (PDA). Also, the electronic device can be an arbitrary portable electronic device including a device that combines two or more functions among these devices.

The electronic device 100 includes a memory 110, a processor unit 120, a first wireless communication subsystem 130, a second wireless communication system 131, a first light sensor 192, a camera subsystem 193, a second light sensor 194, an external port 160, an audio subsystem 150, a speaker 151, a microphone 152, an Input/Output (I/O) system 170, a touchscreen 180, and a different input/control unit 190. Also, a plurality of memories 110 and external ports 160 included in the electronic device can be provided.

The processor unit 120 can include a memory interface 121, one or more processors 122, and a peripheral interface 123. In some cases, the entire processor unit 120 may be called a processor. The memory interface 121, the one or more processors 122 and/or the peripheral interface 123 can be separate elements or can be integrated in one or more integrated circuits.

The processor 122 executes various software programs to perform various functions for the electronic device 100. In addition, the processor 122 performs processes and controls for voice communication and data communication. In addition to these general functions, the processor 122 executes a specific software module (instruction set) stored in the memory 110 to perform various specific functions corresponding to the relevant module. That is, the processor 122 performs a method of an embodiment of the present disclosure in cooperation with software modules stored in the memory 110.

According to an exemplary embodiment of the present disclosure, the processor 122 controls a graphic module 113 stored in the memory 110 to show a change in a status of a first object by transforming a shape of the first object. At this point, the processor 122 can control to output a second object and transform the shape of the first object.

According to another exemplary embodiment of the present disclosure, in case of receiving a status change instruction of the first object via wireless communication, the processor 122 can control the graphic module 113 stored in the memory 110 to display the second object in response to the status change instruction of the first object and perform a status change of the first object.

Various elements of the electronic device 100 can be coupled via one or more communication buses (reference numeral not shown) or stream lines (reference numeral not shown).

The external port 160 is used for directly connecting the electronic device 100 to other electronic devices or indirectly connecting the electronic device 100 to other electronic devices via a network (for example, the Internet, an Intranet, a wireless LAN, etc.) For example, the external port 160 can be a Universal Serial Bus (USB) or a FIREWIRE port, etc. but the invention is not limited thereto.

A movement sensor 191 and a first light sensor 192 can be coupled to the peripheral interface 123 to enable various functions. For example, the movement sensor 191 and the first light sensor 192 can be coupled to the peripheral interface 123 to detect movement of the electronic device 100 and detect light from the outside, respectively. Besides, other sensors such as a position measurement sensor, a temperature sensor, a living body sensor, etc. can be coupled to the peripheral interface 123 to perform relevant functions.

A camera subsystem 193 can be coupled to a second light sensor 194 to perform a camera function such as a photo, video clip recording, etc. The second light sensor 194 can be an image pick-up device such as a Charged Coupled Device (CCD) and a Complementary Metal Oxide Semiconductor (CMOS) device.

Also, the electronic device 100 performs a communication function via one or more wireless communication systems 130 and 131. The wireless communication subsystems 130 and 131 can include a Radio Frequency (RF) receiver and an RF transceiver and/or a light (for example, infrared) receiver and a light transceiver. The first wireless communication subsystem 130 and the second wireless communication subsystem 131 can be classified depending on a communication network via which the electronic device 100 communicates. For example, the communication network can include a communication subsystem designed to operate via a Global System for Mobile Communication (GSM) network, an Enhanced Data GSM Environment (EDGE) network, a Code Division Multiple Access (CDMA) network, a Wide-CDMA (W-CDMA) network, a Long Term. Evolution (LTE) network, an Orthogonal Frequency Division Multiple Access (OFDMA) network, a Wireless Fidelity (Wi-Fi) network, a WiMax network, and/or a Bluetooth network, but the invention is not limited thereto. The wireless communication subsystems 130 and 131 according to the present disclosure can be a wireless communication unit for receiving a status change instruction of the first object.

The audio subsystem 150 can be coupled to a speaker 151 and a microphone 152 to take charge of voice recognition, voice duplication, digital recording, and input/output of an audio stream such a telephone function. That is, the audio subsystem 150 communicates with a user via the speaker 151 and the microphone 152. The audio subsystem 150 receives a data stream via the peripheral interface 123 of the processor unit 120, and converts the received stream to an electric stream. The converted electric stream (electric signal) is transferred to the speaker 151. The speaker 151 converts the electric stream to a sound wave audible by a human being and outputs the same. The microphone 152 converts a sound wave transferred from a human being or other sound sources to an electric stream. The audio subsystem 150 converts the received electric stream to an audio data stream, and transfers the converted audio data stream to the peripheral interface 123. The audio subsystem 150 can include an attachable and detachable ear phone, a head phone, or a headset.

The I/O subsystem 170 includes a touchscreen controller 171 and/or a different input controller 172. The touchscreen controller 171 is coupled to a touchscreen 180. The touchscreen 180 and the touchscreen controller 171 can detect a contact and a movement or stoppage of them using an arbitrary multi-touch detection technology including the other proximity sensor arrangements or the other elements as well as capacitive, resistive, infrared, and surface acoustic wave technologies for determining one or more contact points with the touchscreen 180. The different input controller 172 can be coupled to a different input/control unit 190. The different input/control unit 190 can include one or more up/down buttons for volume control. Also, the button can be a push button, a rocker button, a rocker switch, a thumb-wheel, a dial, a stick, and/or a pointer device such as a stylus, and the like.

The touchscreen 180 provides an input/output interface between the electronic device 100 and a user. That is, the touchscreen 180 transfers the user's touch input to the electronic device 100. Also, the touchscreen 180 is a medium for showing an output from the electronic device 100 to the user. That is, the touchscreen 180 shows a visual output to the user. The visual output is represented in the form of text, graphic, video, and a combination of these.

Various displays can be used for the touchscreen 180. The touchscreen can be a Liquid Crystal Display (LCD), a Light Emitting Diode (LED), a Light Emitting Polymer Display (LPD), an Organic Light Emitting Diode (OLED), an Active Matrix Organic Light Emitting Diode (AMOLED), a 3-Dimensional (3D) display, or a Flexible LED (FLED), but is not limited thereto. In addition, the touchscreen according to the present disclosure outputs a status change process of a first object, and outputs a process where a second object transforms a shape of the first object.

The memory 110 can be coupled to the memory interface 121. The memory 110 can include a high speed random access memory such as one or more magnetic disc storage devices and/or a non-volatile memory, one or more optical storage devices and/or a flash memory (for example, NAND, NOR).

The memory 110 stores software. The software includes an operating system software module 111, a communication software module 112, a graphic software module 113, a user interface software module 114, a CODEC software module 115, a camera software module 116, one or more application modules 117, and the like. Also, since a module which is a software element can be expressed as a set of instructions, the module is also expressed as an instruction set. The module is also expressed as a program, and a software module is also expressed as a module.

Throughout the specification, one or more modules including instructions for performing various methods of the present disclosure can be stored in the memory 110.

The operating system module 111 includes various software elements for controlling a general system operation. The control of the general system operation denotes memory management and control, storage hardware (device) control and management, power control and management, etc., for example. The operation system software also performs a function for smoothing communication between various hardware devices and various software modules.

The communication module 112 can enable communication with other electronic devices such as a computer, a server and/or a portable terminal.

The graphic module 113 includes various software elements for providing and displaying graphics on the touchscreen 180. A terminology of graphics denotes text, a web page, an icon, a digital image, a video, animation, and the like. In addition, the graphic module 113 changes a status of the first object under control of the processor 122. Here, a status change or a status change process denotes operations such as deletion, sharing, transmission, storing, and the like. At this point, the graphic module 113 outputs the second object to transform a shape of the first object, thereby changing a status of the first object.

Here, as an embodiment, the second object can be defined depending on a kind (for example, image data, moving image data, music data, and the like) of the first object. As another embodiment, the second object can be defined depending on a change status (for example, deletion, copy, transmission, and the like) of the first object.

The user interface module 114 includes various software elements related to the user interface. The user interface module includes content regarding how a status of the user interface changes or under which condition a change of the user interface status is made.

The CODEC module 115 can include software elements related to encoding and decoding of a video file. The CODEC module 115 can include an MPEG module and/or a video stream module such as an 11.264 module. Also, the CODEC module 115 can include various CODEC modules for various audio files such as AAA, AMR, WMA, and the like.

The camera module 116 includes a camera related software element enabling camera related processes and functions.

The application module 117 includes a browser, an electronic (e)-mail, an instant message, word processing, keyboard emulation, an address book, a touch list, a widget, a Digital Right Management (DRM), voice recognition, voice duplication, a position determine function, a position-based service, and the like. The memory 110 can include additional modules (instructions) besides the above-described modules. Alternatively, the memory cannot use a portion of the modules (instructions) when needed.

Also, various functions of the electronic device 100 mentioned above or to be mentioned below can be executed by hardware and/or software and/or combination of these including one or more stream processes and/or Application Specific Integrated Circuit (ASIC).

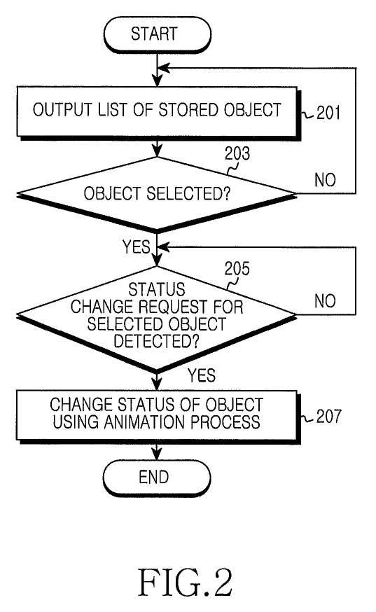

FIG. 2 is a flowchart illustrating a process for showing change in a status of an object in an electronic device according to an exemplary embodiment of the present disclosure.

Referring to FIG. 2, an object is data stored in the electronic device and includes document data, image data, media data, message data, e-mail data, and the like. Changes in a status of the object denotes performing operations such as deletion, sharing, transmission, storing, and the like on the object selected by a user. In addition, the object can be information (for example, an icon) of an application installed in advance in the electronic device. Deletion of an application can be one of changes in a status of the object.

In addition, a process for installing an application in the electronic device can be one of changes in a status of the object.

First, the electronic device displays a list of stored objects in step 201, and proceeds to step 203 to determine whether an input of a user selecting an object whose status is to be changed is detected.

Here, the electronic device can display an entire list of objects stored in the electronic device or output a list of objects for each category (for example, photo album, music album, e-mail, message, and the like)

If an input from a user is not detected in step 203, the electronic device proceeds to step 201 to re-perform the process for displaying a list of objects.

Alternatively, if an input from a user who selects an object is detected in step 203, the electronic device proceeds to step 205 to determine whether the user's input requesting (instructing) a status change of the selected object is detected. Here, the user's input can request delete the selected object, attach the selected object to an e-mail or a message, or register the selected object using a social network service, and the like.

If the user's input requesting the status change of the selected object is not detected in step 205, the electronic device returns to step 205.

Alternatively, if the user's input for requesting a status change of the selected object is detected in step 205, the electronic device proceeds to step 207 to process a status change of the selected object using animation processing.

Here, step 207 can be a process where a different object besides the output object is output to change a status of the object output in advance while transforming a shape of the object output in advance, or a process for animating a status change of the object output in advance using a movement Of the different object besides the object output in advance. For example, when detecting a request for deleting a first object from a user, the electronic device can display a second object, modify opacity of the first object, or delete the first object while removing a portion of the region of the first object.

Alternatively, when detecting a request for deleting the first object from the user, the electronic device can display the second object, and move the second object or a portion of the second object while the first object is being deleted. After that, the electronic device ends the present algorithm.

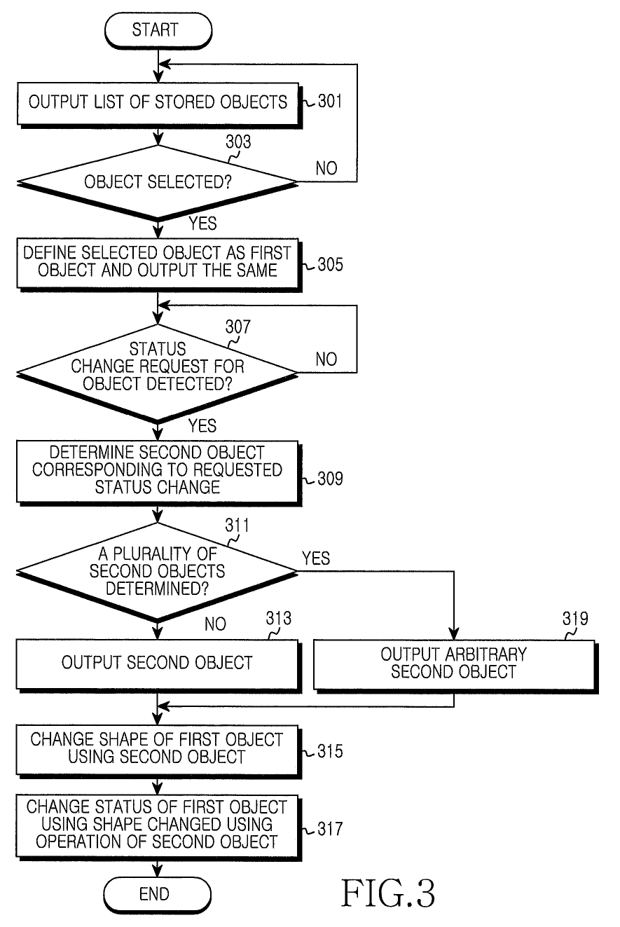

FIG. 3 is a flowchart illustrating a process for animating a change in a status of an object in an electronic device according to an exemplary embodiment of the present disclosure.

Referring to FIG. 3, the electronic device displays a list of stored objects in step 301, and proceeds to step 303 to determine whether an input from a user for selecting an object whose status is to be changed is detected.

If the input from the user is not detected in step 303, the electronic device returns to step 301.

Alternately, if the input from the user who selects the object is detected in step 303, the electronic device proceeds to step 305 to determine the object that is selected by the user in step 303 as a first object and display the object. After that, it proceeds to step 307 to determine whether a status change request (instruction) on the first object is detected. For example, in the case where the electronic device defines one (data selected by the user) of a plurality of image data stored in the electronic device as the first object, a request for deleting image data or setting data as a background image can be the status change request.

If the status change request of the first object is not detected in step 307, the electronic device returns to step 307 for detecting a status change request.

Alternatively, if the status change request of the first object is detected in step 307, the electronic device proceeds to step 309 to determine a second object corresponding to the status change requested by the user. Here, the second object denotes an object that changes a status of the first object while transforming a shape of the first object. According to a preferred embodiment of the present disclosure, the second object can be grouped and defined for each status change. For example, an electronic device according to the present disclosure can define second objects used for deleting the first object, second objects used for transmitting the first object, and second objects used for sharing the first object, and the like, and then use the second object corresponding to a status of the first object which a user intends to change.

After that, the electronic device proceeds to step 311 to determine whether a plurality of second objects corresponding to a status change are determined.

If the plurality of objects are determined in step 311, the electronic device proceeds to step 319 to output an arbitrary second object. At this point, to prevent the same second object from being displayed depending on a status change, the electronic device can improve satisfaction of a user by sequentially selecting and displaying a plurality of second objects or irregularly selecting and displaying a plurality of second objects.

Meanwhile, in the case where one second object is determined in step 311, the electronic device proceeds to step 313 to display the second object determined in step 309.

The electronic device having displayed the second object in steps 313 and 319 proceeds to step 315 to transform a shape of the first object using the second object, and then proceeds to step 317 to animate a change in a status of the first object using a shape changed depending on an operation of the second object.

For example, in the case where a user intends to delete the first object, the second object can be positioned on the first object, and opacity of the first object is reduced depending on movement of the second object, and so the first object can be deleted.

In addition, in the case where the user intends to attach the first object to a message, an e-mail, and the like, the second object can be positioned on the first object, and a specific effect is applied to the first object depending on movement of the second object and the first object to which the specific effect has been applied can be attached as an attached file.

As described above, the electronic device that has animated a status change of the first object finishes the present algorithm.

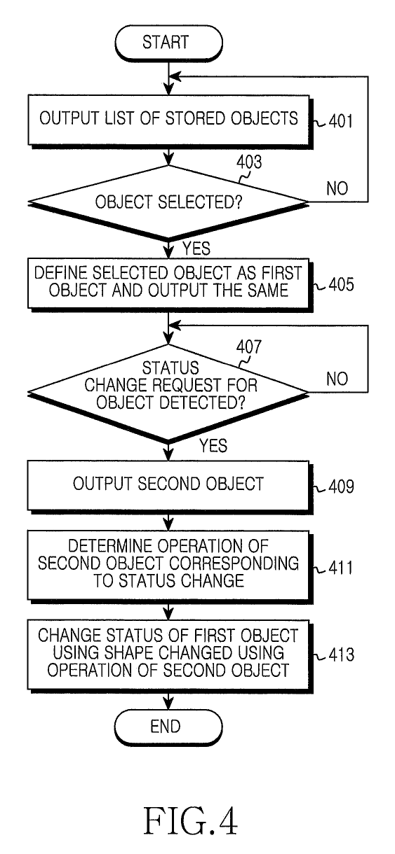

FIG. 4 is a flowchart illustrating a process for animating a status change of an object in an electronic device according to an exemplary embodiment of the present disclosure.

Referring to FIG. 4, the electronic device displays a list of stored objects in step 401 first, and proceeds to step 403 to determine whether an input from a user for selecting an object whose status is to be changed is detected.

If the input of the user selecting the object is not detected in step 403, the electronic device returns to step 401.

Alternatively, if the input of the user selecting the object is detected in step 403, the electronic device proceeds to step 405 to define the object selected by the user in step 403 as a first object and output the same, and proceeds to step 407 to determine whether a status change request for the first object is detected. For example, in case of selecting one (data selected by the user) of image data stored in the electronic device as a first object, the user can delete the selected first object or set the selected first object as a background image. At this point, a request for deleting the first object or setting the first object as the background image can be a status change request.

If the status change request for the first object is not detected in step 407, the electronic device returns to step 407 for detecting a status change request,

Alternatively, if the status change request for the first object is detected in step 407, the electronic device proceeds to step 409 to display a second object that transforms concurrently with a change of shape of the first object. Though the electronic device displays a second object that transforms depending on a status change in the above, FIG. 4 illustrates that the same second object can change a status of the first object using a different operation depending on a status change.

Consequently, the electronic device proceeds to step 411 to determine an operation of the second object corresponding to a status change, and then proceeds to step 413 to animate a status change of the first object depending on an operation of the second object. After that, the electronic device ends the present algorithm.

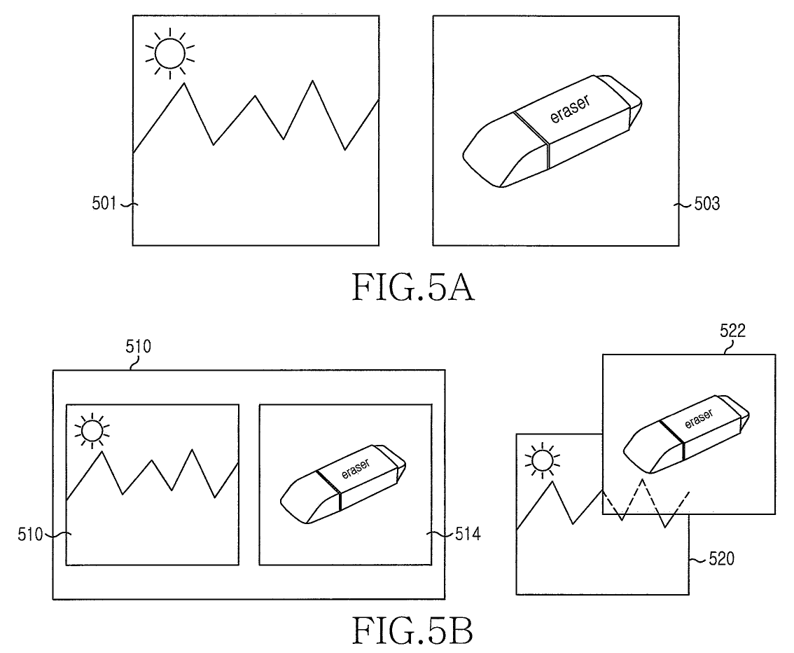

Change in a shape of the first object can be animated using movement of the second object mentioned in FIGS. 3 and 4. FIG. 5 is a view illustrating an object output by an electronic device according to one exemplary embodiment of the present disclosure.

Referring to FIG. 5, the electronic device displays a first object 501 which is data stored in advance, and a second object 503 which is changing a shape of the first object 501 as illustrated in FIG. 5A.

At this point, the electronic device can display the first object and the second object on a display unit, simultaneously as illustrated in FIG. 5B. The electronic device displays the first object 501 and the second object 503 on the same layer 510, and then transforms a shape of the first object 501 using the second object 503.

In addition, the electronic device can stack a layer on the display unit, and can process to display the first object on the display unit and display the second object on the stacked layer as illustrated in FIG. 5C. The electronic device can transform a shape of a first object 520 using a second object 522 of the stacked layer.

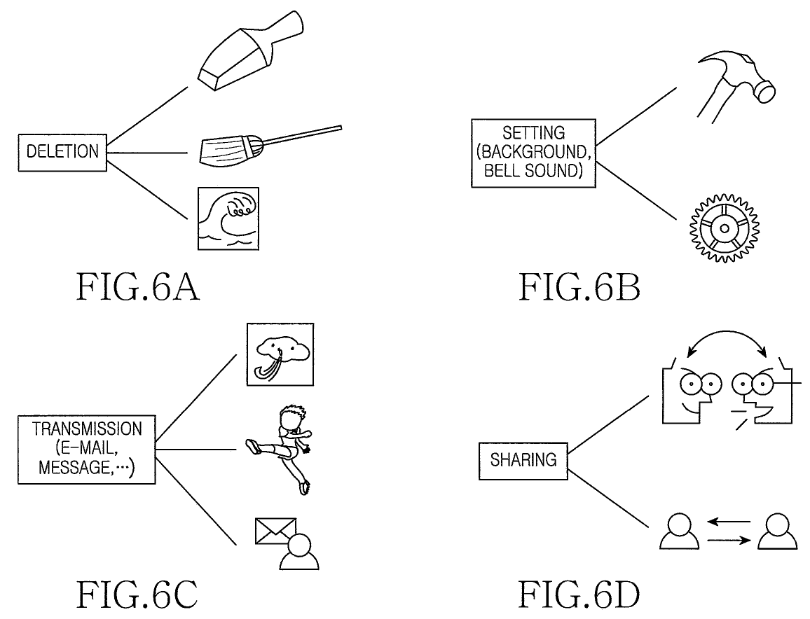

FIG. 6 is a view illustrating configuration for a second object used by an electronic device according to an exemplary embodiment of the present disclosure.

Referring to FIG. 6, the electronic device designates the second object depending on a status change of a first object, and uses the second object corresponding to a status change according to a user's request.

Here, status changes of the first object can include deletion, setting, transmission, sharing, and the like.

Deletion is to delete a first object stored in the electronic device, and setting is to apply a function (background image, bell sound, and the like) of the electronic device to the first object. In addition, transmission is to transmit the first object stored in the electronic device to a different electronic device. Transmission is to attach the first object to a message, an e-mail, or register the first object in a social network service.

Also, sharing is to allow the first object stored in the electronic device to be accessed by other electronic devices.

As illustrated in FIG. 6A, a second object corresponding to a status change “deletion” can be a cleaner, a broom, waves, and the like. A second object corresponding to the cleaner can inhale the first object, and a second object corresponding to the broom can sweep the first object. In addition, the first object can be deleted from the electronic device via an effect of being pushed by the second object.

In addition, as illustrated in FIG. 6B, for a second object corresponding to a status change “setting”, an image or a character implying a tool and configuration can be used.

Therefore, the first object can be set to a bell sound or a background image of the electronic device depending on an operation or movement of the second object. Until the status change of the first object is completed, the second object can perform a specific operation.

In addition, as illustrated in FIG. 6C, a second object corresponding to a status change “transmission” can be defined. As illustrated in FIG. 6D, a second object corresponding to a status change “sharing” can be defined.

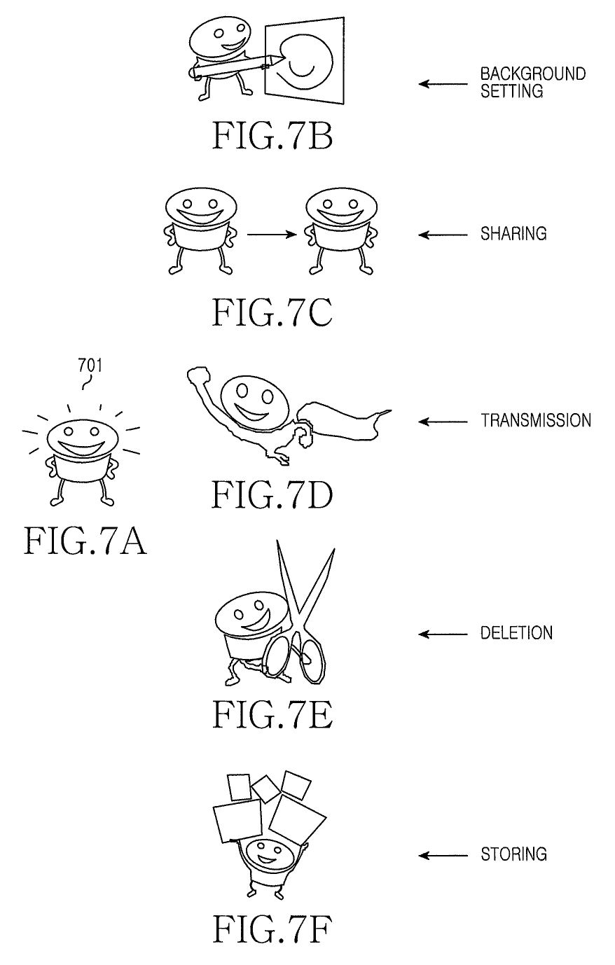

FIG. 7 is a view illustrating configuration of a second object used by an electronic device according to an exemplary embodiment of the present disclosure.

Referring to FIG. 7, the electronic device defines one second object regardless of a status change of a first object and can process to allow the second object to perform different operations depending on a status change corresponding to a user's request.

That is, FIG. 7A illustrates a second object 701. The electronic device can set a first object as a background image by operating the second object as illustrated in FIG. 7B. FIG. 7B illustrates an operation of the second object representing setting the first object as the background image.

In addition, the electronic device can allow the first object to be shared by operating the second object as illustrated in FIG. 7C. FIG. 7C illustrates an operation of the second object representing sharing the first object with other devices or users.

In addition, the electronic device can transmit the first object by operating the second object as illustrated in FIG. 7D. FIG. 7D illustrates an operation of the second object representing attaching the first object to an e-mail, a message, and the like, or registering the first object in a social network service.

In addition, the electronic device can process to delete the first object by operating the second object as illustrated in FIG. 7E. FIG. 7E illustrates an operation of the second object representing deleting the first object stored in advance.

In addition, the electronic device can store the first object by operating the second object as illustrated in FIG. 7F. FIG. 7F illustrates an operation of the second object representing storing the output first object.

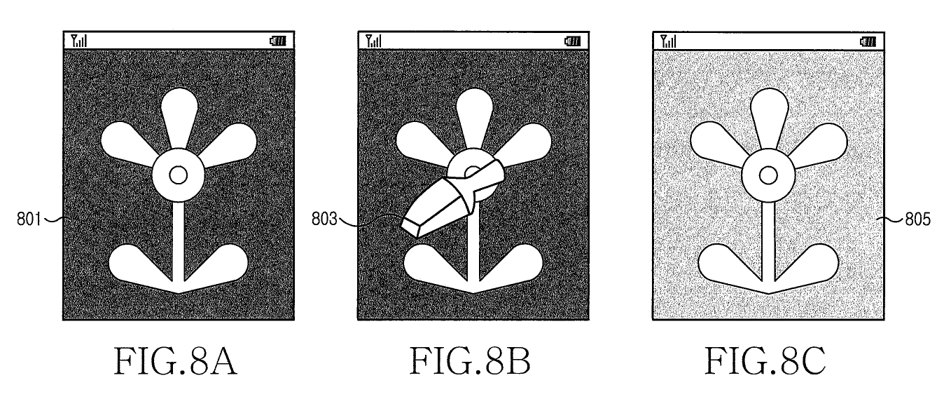

FIG. 8 is a view illustrating a process for changing a status of an object in an electronic device according to an exemplary embodiment of the present disclosure.

Referring to FIG. 8, the electronic device displays a first object, which is an object selected by a user, on a display unit (801) as illustrated in FIG. 8A.

At this point, though the electronic device has displayed image data as the first object as illustrated, the electronic device can display document data, e-mail data, message data, and the like, as the first object. That is, the first object denotes all objects whose status can be changed (for example, deleted, transmitted, and shared) by the user of the electronic device.

In the case where the user intends to change a status of the first object, the electronic device process to display a second object on the output first object.

At this point, the second object denotes an object that changes a status of the first object while transforming a shape of the first object.

For example, when detecting a status change request for deleting the first object, the electronic device outputs a second object 803 such as a cleaner defined to delete the first object while transforming a shape of the first object on the first object as illustrated in FIG. 8B. At this point, the second object 803 can transform a shape of the first object while being positioned on the first object, or transform the shape of the first object corresponding to a movement while moving on the first object.

That is, an effect of deleting an object while lowering opacity of the first object 805 using a second object as illustrated in FIG. 8C. The first object will be deleted from the electronic device at a point where the opacity lowers to a predetermined value or less.

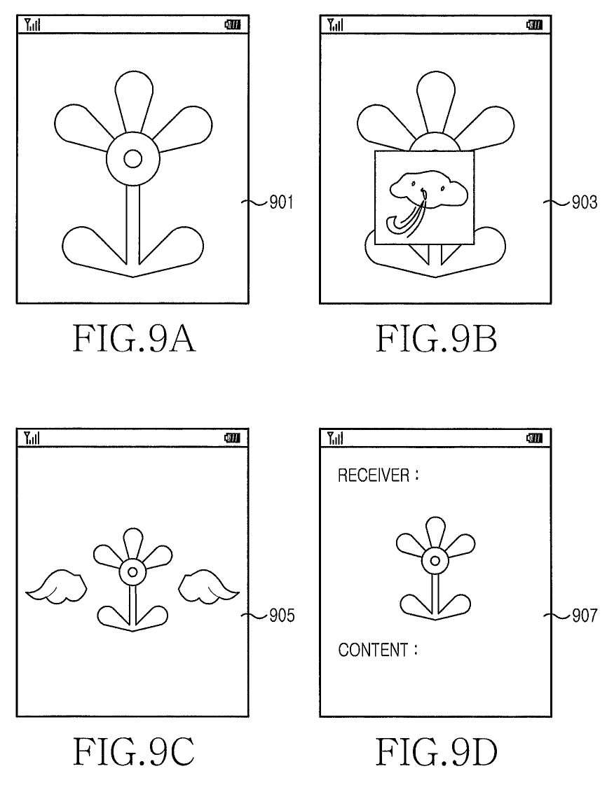

FIG. 9 is a screen illustrating a process for animating a status change of an object in an electronic device according to an exemplary embodiment of the present disclosure.

Referring to FIG. 9, the electronic device displays a first object 901, which is an object selected by a user, on a display unit as illustrated in FIG. 9A.

At this point, though the electronic device has output image data as the first object as illustrated, the electronic device can output document data, e-mail data, message data, and the like. as the first object. That is, the first object denotes all objects whose status can be changed (for example, deleted, transmitted, and shared) by the user of the electronic device.

In the case where the user intends to change a status of the first object, the electronic device process to display a second object on the first object.

At this point, the second object denotes an object that changes a status of the first object while transforming a shape of the first object.

For example, when detecting a request for transmitting a first object (for example, attaching a first object to an e-mail, a message, and the like) from a user, the electronic device outputs a second object 903 such as a wind defined to transmit the first object while transforming a shape of the first object on the first object as illustrated in FIG. 9B. At this point, the second object can transform the shape of the first object while being positioned on the first object, or transform the shape of the first object corresponding to a movement while moving on the first object.

For example, an effect as if the first object were transmitted by the second object is applied to the first object (905) and the shape of the first object is transformed as illustrated in FIG. 9C.

The first object whose shape has been transformed by the second object is applied (907) as an attached file of a function (for example, message function) requested by the user.

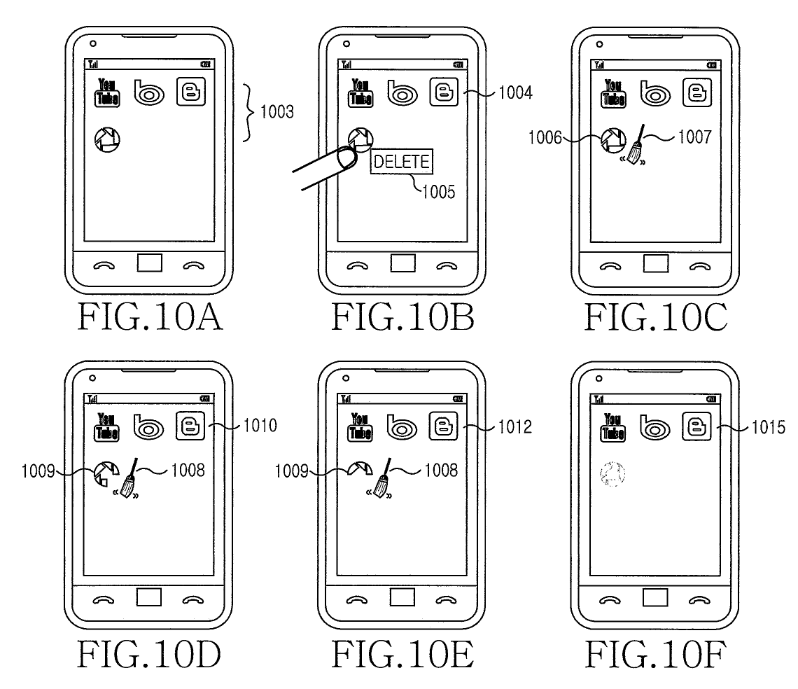

FIG. 10 is a view illustrating a process for changing a status of an object in an electronic device according to an exemplary embodiment of the present disclosure.

Referring to FIG. 10, changing a status of an object denotes deleting an application installed in advance.

The electronic device for changing a status of icons 1003 for an application installed in advance as illustrated in FIG. 10A.

An icon is for controlling an application. A user can execute an application or delete an installed application using an icon. Here, an icon of an application can be an object. Executing or deleting an application can be changing a status of an object.

In the case where the user intends to select one of applications 1004 installed in advance and delete the selected application 1005, the electronic device identify an icon 1006 which the user intends to delete as a first object and display a second object 1007 as illustrated in FIG. 10C.

After that, the electronic device can delete the first object using the second object as illustrated in FIGS. 10D to 10F. FIGS. 10D to 10F illustrate a status change degree of the first object. The electronic device can inform a degree in which the status change progresses by transforming the shape of the first object. That is, depending on a progression degree, the first object 1009 of FIG. 10D is deleted by ¼ by the second object 1008, and the rest of the first object is maintained (1010). After that, the first object 1013 of FIG. 10E is deleted by ½ by the second object 1014, and the rest of the first object is maintained (1012).

Finally, as illustrated in FIG. 10F, the first object is deleted and the rest of applications are left (1015).

Methods according to embodiments described in claims and/or specification of the present disclosure can be implemented in the form of software, hardware, or a combination of these.

In case of implementation in the form of software, a computer readable storage medium storing one or more programs (software modules) can be provided. The one or more programs stored in the computer readable storage medium are configured for execution by one or more processors inside the electronic device. The one or more programs include instructions for allowing the electronic device to execute methods according to the embodiments described in claims and/or specification of the present disclosure.

These programs (software modules, software) can be stored in a random access memory, a non-volatile memory including a flash memory, Read Only Memory (ROM), an Electrically Erasable Programmable Read Only Memory (EEPROM), a magnetic disc storage device, a Compact Disc (CD)-ROM, Digital Versatile Discs (DVDs) or other types of optical storage devices, and a magnetic cassette. Alternatively, these programs can be stored in a memory configured in a combination of some or all of these. Also, a plurality of respective memories can be provided.

Also, these programs can be stored in an attachable storage device that can access the electronic device via a communication network such as the Internet, Intranet, Local Area Network (LAN), Wide LAN (WLAN), and a Storage Area Network (SAN), or a communication network configured in combination of these. This storage device can access the electronic device via an external port.

Also, a separate storage device on a communication network can access a portable electronic device.

As described above, the present disclosure is intended for applying an effect to an object whose status changes in an electronic device and may improve a user's satisfaction regarding a status change process of an object using a different object besides the object which the user intends to change.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An electronic device for animating a status change on an object in an electronic device, the device comprising:
a display unit configured to display a status change animation of a first object;
an input unit configured to receive a status change instruction on the first object;
a memory unit configured to store at least one module; and
one or more processors configured to execute the at least one module,
wherein the at least one module is configured to perform a status change animation on the first object using a second object.

2. The electronic device of claim 1, wherein the module performs the status change animation concurrently with a movement of at least a portion of the second object.

3. The electronic device of claim 1, wherein the status change instruction comprises at least one of deletion, transmission, sharing, and storing.

4. The electronic device of claim 3, wherein if the status change instruction is sharing, the at least one module is configured to display the second object to share data with the first object.

5. The electronic device of claim 3, wherein if the status change instruction is deleting, the at least one module is configured to reduce opacity of the first object as the second object approaches to the first object.

6. The electronic device of claim 3, wherein if the status change instruction is transmitting, the at least one module is configured to display the second object to receive data transmitted from the first object.

7. A method for performing a status change of an object in an electronic device, the method comprising:
displaying a first object;
receiving a status change instruction of the first object; and
performing a status change animation on the first object using a second object in response to the status change instruction.

8. The method of claim 7, wherein the status change animation is performed concurrently with a movement of at least a portion of the second object.

9. The method of claim 7, wherein the status change instruction comprises at least one of deletion, transmission, sharing, and storing.

10. The method of claim 9, wherein if the status change instruction is sharing, the at least one module is configured to display the second object to share data with the first object.

11. The method of claim 9, wherein if the status change instruction is deleting, the at least one module is configured to reduce opacity of the first object as the second object approaches to the first object.

12. The method of claim 9, wherein if the status change instruction is transmitting, the at least one module is configured to display the second object to receive data transmitted from the first object.

13. An electronic device for performing a status change animation on an object, the device comprising:
a display unit configured to display a first object;
an input unit configured to receive a status change instruction on the first object; and
processing circuitry configured to perform a status change animation on the first object using a second object in response to the status change instruction.

14. The electronic device of claim 13, wherein the processing circuitry is configured to perform the status change animation concurrently with a movement of at least a portion of the second object.

15. The electronic device of claim 13, wherein the status change instruction comprises at least one of deletion, transmission, sharing and storing.

16. The electronic device of claim 13, wherein the first object and the second object are displayed on either the same layer or different layers, respectively.

17. An electronic device for performing a status change animation of an object in an electronic device, the device comprising:
a wireless communication unit;
a touchscreen display configured to receive a status change and display a status change animation of a first object;
one or more processors configured to operate by being connected with the touchscreen display and the wireless communication unit;
a memory configured to store at least one module,
wherein the at least one module is configured to display animation of a second object in response to a status change instruction on the first object received via the wireless communication unit, thereby to perform a status change animation of the first object.

18. The electronic device of claim 17, wherein the module is configured to performs the status change animation of the first object concurrently with a movement of at least a portion of the second object.

19. The electronic device of claim 17, wherein if the status change instruction is sharing, the at least one module is configured to display the second object to share data with the first object.

20. The electronic device of claim 17, wherein if the status change instruction is deleting, the at least one module is configured to reduce opacity of the first object as the second object approaches to the first object.
